(19) United States
(12) Patent Application Publication
(10) Pub. No.: US 2018/0110215 A1
(43) Pub. Date: Apr. 26, 2018

(54) Foot-hold animal trapping apparatus

(71) Applicant: Kim Harris, Conrad, MT (US)

(72) Inventor: Kim Harris, Conrad, MT (US)

(21) Appl. No.: 15/732,234

(22) Filed: Oct. 10, 2017

Related U.S. Application Data
(60) Provisional application No. 62/496,667, filed on Oct. 25, 2016.

(51) Int. Cl. A01M 23/26

(52) U.S. Cl. CPC A01M 23/26; A01M 23/36

(57) ABSTRACT

An animal trap comprising a pair of complementary curved jaws rotatably mounted on a frame or base plate, and springs on the frame cooperating with a pair of opposed levers for urging the jaws toward each other from an open position to a closed or animal foot-holding restraining position. A foot pan is located on the frame between the jaws. A trigger-release assembly is employed to restrain the jaws in the open position by being engaged between the pan and jaws. When the animal steps on the pan causing it to move axially downward, the trigger-release assembly is activated causing the spring-biased levers to close the jaws about the foot of the animal.

### RELATED APPLICATION

The present application claims priority for all purposes on and of my prior provisional application, Ser. No. 62/496,667, filed Oct. 25, 2016, entitled: Foot-Hold Animal Trapping Apparatus. To perfect this claim, a duly executed Application Data Sheet Under 37 CFR 1.76 is being filed concurrently with this application. The aforementioned prior pending provisional application, Ser. No. 62/496,667, etc. and the Application Data Sheet hereby are incorporated in and made part of this application.

### FIELD OF THE INVENTION

The present invention relates generally to animal traps, and more specifically, to a novel foot-holding, spring-biased, portable trap suitable for restraining small animals without causing injury to same.

### DESCRIPTION OF THE PRIOR ART

Portable, spring-biased, animal traps for snaring small animals are well known. For example, U.S. Pat. No. 4,972,626 (Medvetz) describes an animal trap comprising a pair of complementary jaws rotatably mounted on a frame or base plate, and springs on the frame cooperating with a pair of opposed levers for urging the jaws toward each other from an open position to a closed or animal foot-holding restraining position. A pivotally-mounted pan is located on the frame between the jaws. A trigger-release assembly including a “dog” is also pivotally mounted on the frame and is employed to restrain the jaws in the open position by being engaged with the pivotal pan. When the animal steps on the pan causing it to pivot, the “dog” is released causing the spring-biased levers to close the jaws about the foot of the animal. Other prior devices in this general category may be read about in the following additional patents: U.S. Pat. No. 4,272,907 (Skapura); U.S. Pat. No. 4,486,972 (Helfrich); U.S. Pat. No. 5,691,510 (Turman); and U.S. Pat. No. 7,421,821 (Butera).

Although the prior traps of the Medvetz-type have become popular and are in widespread use, because the “dog” is mounted away from the pan, among other reasons, so-called “dead spots” or “dead zones” prevent the pan from being depressed if the animal's foot lands in the wrong place on the pan.

Accordingly, a vexing need exists for providing a foot-hold trap of the foregoing type where the activating pan and the triggering mechanism are so configured and arranged as to avoid the “dead spots” in prior art pan-activated foot-hold animal traps. This need is met by the present invention which briefly described has as its primary object the provision of an animal trap where the pan assembly is “center driven” i.e. the pan moves axially downwardly toward the frame when stepped on by an animal's foot and activates a novel trigger-release assembly located proximal to the pan to cause the trap's jaws to move from the open to the closed position. Such a novel “center driven” pan arrangement has been found to all but eliminate the “dead spot” or dead zone” problem affecting the prior art traps. Another object of the present invention is to provide a novel foot-hold animal trap of the foregoing type which is simple in its construction, comparatively inexpensive in its manufacture, thoroughly efficient and reliable in it use and operation, and otherwise well adapted to the purpose for which it is designed.

The above and numerous other objects of the invention will become evident from the following more detailed description of the invention, taken with reference to the annexed drawings.

### BRIEF DESCRIPTION OF THE DRAWINGS

FIG. 1 is a plan view showing the jaws of a novel foot-hold animal trap according to a preferred embodiment of the invention in an open position.

FIG. 2 is a side view taken along line 2-2 of FIG. 1.

FIG. 3 is a side view taken along line 3-3 of Figure showing the jaws in a closed position.

FIG. 4 is an enlarged cross-section taken along line 4-4 in FIG. 2 showing the inside of the pan support housing according to the invention.

FIG. 5 is a cross-section taken along line 5-5 of FIG. 4 showing the trigger assembly in a first position when the jaws of the trap are open and the trap is “set.”

FIG. 6 is a cross-section taken along line 5-5 of FIG. 4 showing the trigger assembly in a second position when the jaws of the trap are closed.

FIG. 7 is a perspective view taken from below and to the left inside the trigger assembly housing schematically showing the trigger assembly of the invention in the first position where the jaws of the trap are open and the trap is “set.”

FIG. 8 is a plan view showing the jaws of a novel foot-hold animal trap according to a second preferred embodiment of the invention in an open position.

FIG. 9 is a side view taken along line 9-9 of FIG. 8.

FIG. 10 is a side view taken along line 10-10 of FIG. 9 showing the jaws in a closed position.

FIG. 11 is a bottom view taken along line 11-11 of FIG. 9.

FIG. 12 is a schematic side view of the second alternatively preferred embodiment of FIGS. 8-11 showing the trigger assembly in a first position when the jaws of the trap are open and the trap is “set.”

FIG. 13 is a schematic side view of the second alternatively preferred embodiment of FIGS. 8-11 showing the trigger assembly in a second position when the jaws have “sprung.”

FIG. 14 is a schematic view in perspective taken from above and to the right of a portion of the trigger assembly of the second preferred embodiment of the invention.

FIG. 15 is an enlarged fragmentary plan view, partially in cross-section, showing the novel swivel anchoring feature according to the present invention.

### DESCRIPTION OF THE PREFERRED EMBODIMENTS

With reference to the drawings, a first preferred embodiment of my invention will now be described in considerable detail, it being understood that the foregoing detailed description is considered as illustrative only of the principles of the invention. Numerous modifications and changes will readily occur to those skilled in the art and therefore, it is not desired to limit the invention to the exact construction and operation shown and described. Accordingly, all suitable modifications and equivalents falling within the broad scope of the subject matter described herein may be resorted to in carrying out the present invention.

Thus, turning initially to FIGS. 1-3, there is shown a first preferred embodiment of my foot-hold animal trapping apparatus generally indicated by reference sign 10 comprising an elongated base plate 12 affixed to an annular shaped, preferably cylindrical housing 14. Extending from cylindrical housing 14 (and suitably fixed thereto) in directions perpendicular to base plate 12, is a pair of opposed supplemental base plate extensions 16, 18 which terminates, respectively, in a pair of up-standing ears or lugs 20, 22.

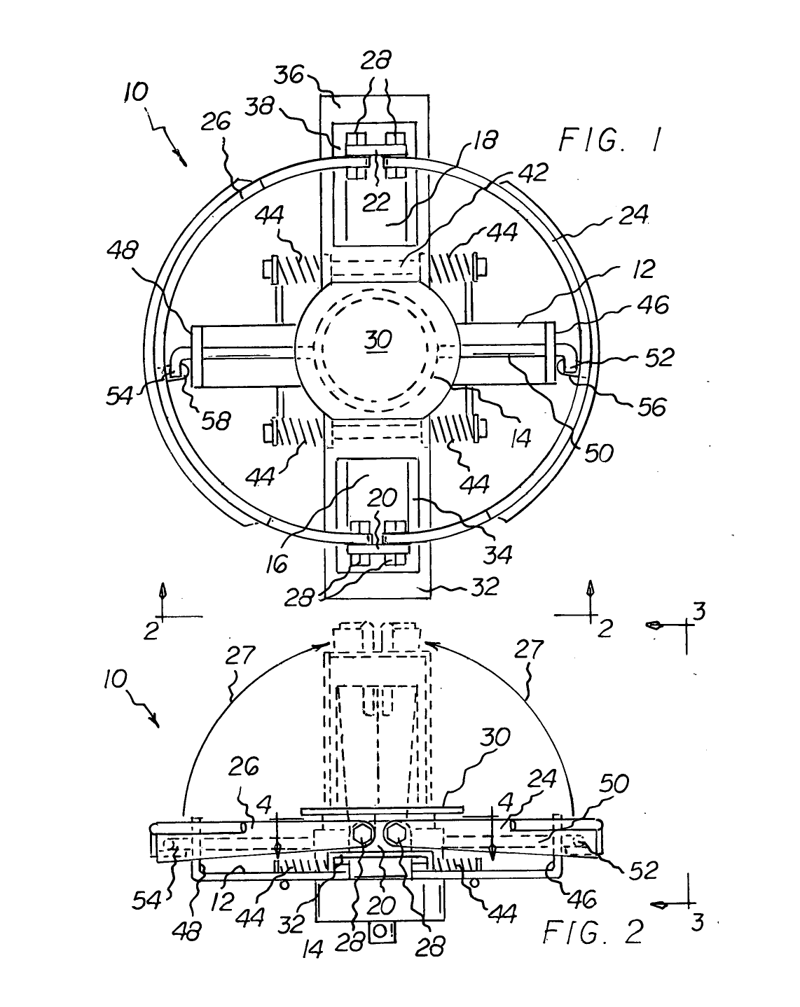

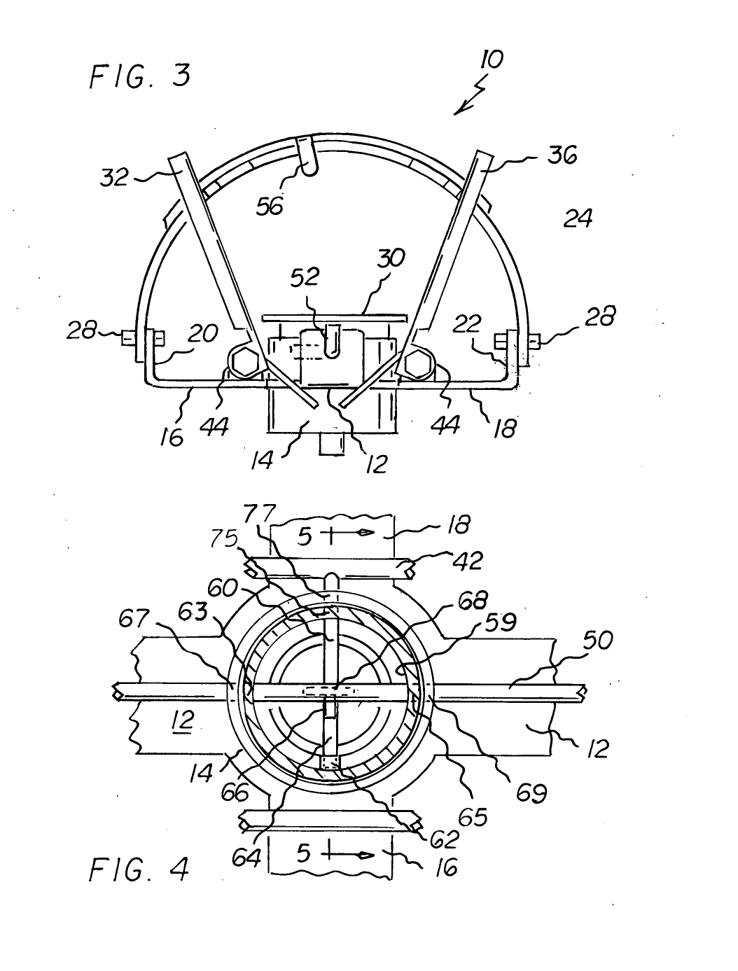

Mounted for rotation on ears 20, 22 via conventional axle journal assemblies 28, is a pair of curved jaw members 24, 26. Jaw members 24, 26 are adapted to move from a first ‘open” position (FIG. 1) to a second “closed’ or trapping position indicated by arrows 27 and the dashed-outlines in FIG. 2. Situated generally centrally of the intersection of perpendicular base plate members 12 and 16, 18, on top of housing 14 is a substantially flat foot panel 30, substantially as depicted (FIGS. 1-3). A pair of opposed lever plates or members 32, 36 suitably are mounted on spring retainers 40, 42 in general axial alignment with supplemental base extensions 16, 18 respectively, substantially as depicted in FIG. 1. The spring retainers 40, 42 suitably fixedly mounted on base plate 12. Each lever plate 32, 36, in turn, has a central opening 34, 38 suitably dimensioned to defined transverse side portions on each lever plate sufficient for engaging jaw members 24, 26 and urging them to move from the “open” position to the “closed” position as is well known in the art. Thus, in FIGS. 1 and 2, the lever plates 32, 36 are shown in the down position corresponding to the “open” or “set” position of jaw members 24, 26 whereas in FIG. 3, the levers 32, 36 are shown in the fully “up” position (caused by the action of spring assemblies 44) corresponding to the “closed” or “trapping” position of the jaw members 24 and 26.

In order to maintain the jaw members in the “open” or “set” position (FIGS. 1 and 2) until an animal steps on the foot panel 30, an elongated locking bar 50 is loosely supported axially on base plate 12 substantially as depicted in FIGS. 1 and 2 by suitable corresponding openings in a pair of upstanding opposed ears or lugs 46, 48, respectively. By this arrangement, locking bar 50 is capable of being rotated relative to base plate 12 from a first or locking position to a second or releasing position. The ends or distal extremities of the locking bar 50 are bent generally at a right angle to the longitudinal axis of the bar 50 to form locking arms 52, 54 facing laterally with respect to the bar 50 in the same direction. Each jaw member 24, 26, in turn, has a corresponding locking tab 56, 58 suitably rigidly fixed to the jaw member at a suitable location thereon so as to be capable of engagement with a corresponding locking arm 52, 54. For this purpose, each locking tab 56, 58 includes a suitable groove in which a corresponding locking arm 52, 54 can be receivingly seated therein in locking engagement. Thus, it will be observed that rotation of locking bar 50 about its longitudinal axis to the position shown in FIGS. 1 and 2 where the locking arms 52, 54 are engaged with locking tabs 56, 58 corresponds to the first or locking position of the apparatus, i.e. the jaw members 24, 26 are set in the “open” position. Similarly, substantially as depicted in FIG. 3, when the locking bar is rotated in the opposite direction (arrow 72, FIG. 6) causing the distally located locking arms 52, 54 to not be in engagement with their corresponding locking tabs 56, 58, the trap apparatus 10 will be sprung and the jaws 24, 26 will be in the upright or trapping position by the action of the spring assembles 44 urging the lever plates 32, 36 to their maximum upright position (FIG. 3).

As mentioned above, an important feature of the present invention is the provision of a foot panel which rather than being pivotally mounted on the trap's base plate, is mounted in such a way as to be caused to move axially in a downward direction essentially perpendicular toward the base plate when an animal steps on the panel. Such an arrangement is designated “center-driven-panel,” and achieves the important advantage of avoiding so-call “dead spots” on the panel where stepping on the panel in certain locations or areas is ineffective to activate the trap's trigger mechanism and “spring the trap.”

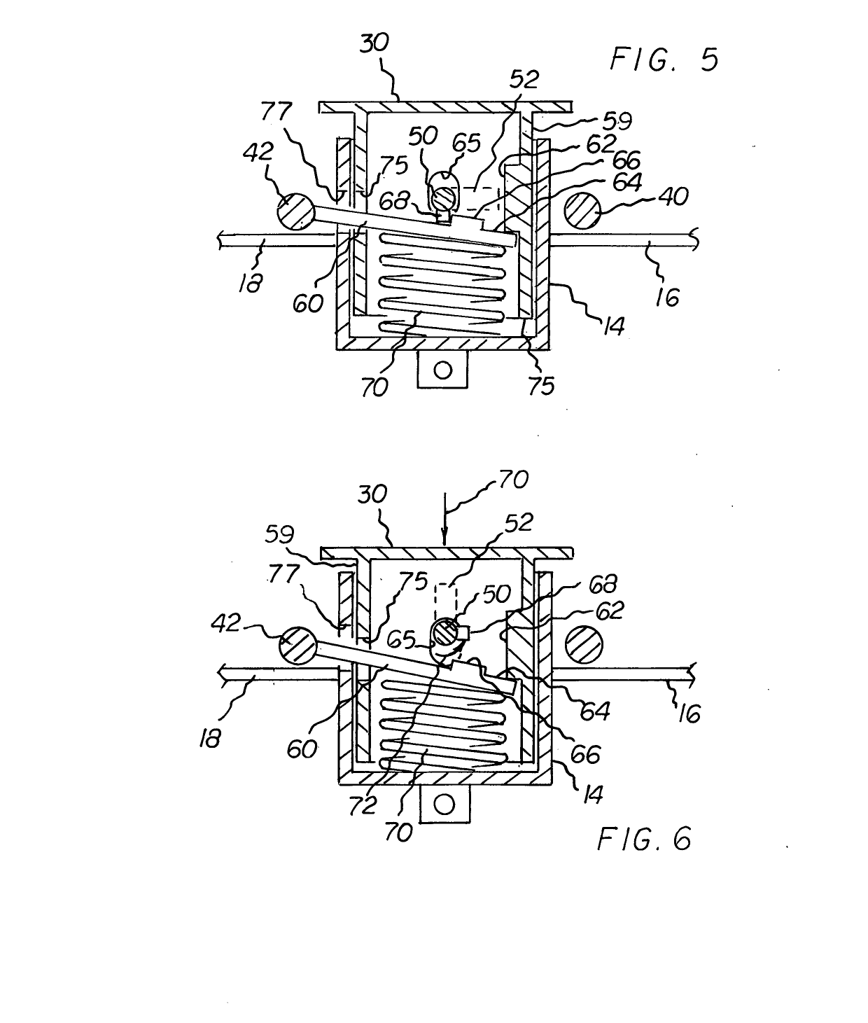

More specifically, turning now to FIGS. 2-7, center or foot pan 30 is suitably fixed substantially symmetrically on downward depending annular, preferably cylindrical, support skirt or collar member 59, which in turn, suitably is fitted to slide up and down to a limited extent within annular, preferably cylindrical, base member 14 in a telescoping manner. The inside wall of skirt member 59 fixedly includes a radially extending abutment member 62 defining a downward facing bearing or cam surface 73, substantially as depicted (FIGS. 5-7). An elongated “trigger” rod member 60 suitably fixed to spring retainer 42 extends through suitable registering openings 75, 77 in the telescoping sidewalls of base member 14 and skirt member 59 to terminate interiorly of skirt member 59 such that the distal extremity of the trigger rod 64 is engaged by bearing surface 73 on the radial abutment 62 affixed to the interior wall of annular skirt member 59.

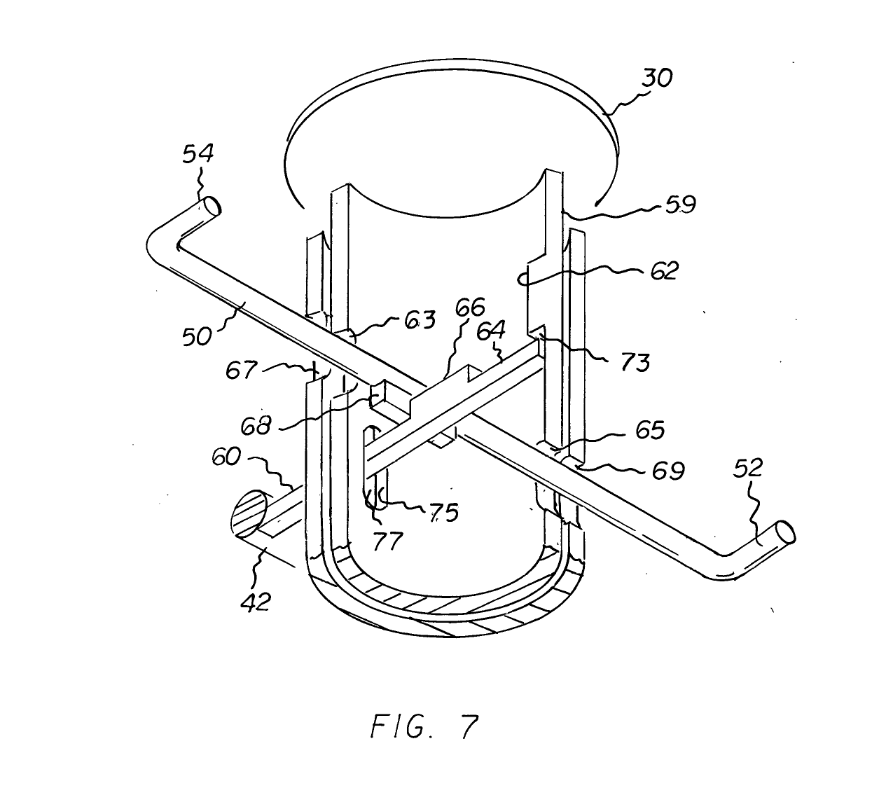

Locking bar 50 extends completely through the telescoping base and skirt members 14, 59, via suitable registering pairs of openings 65, 69 and 63, 67 in the opposed telescoping sidewalls of base member 14 and skirt member 59, respectively, to generally lie within the interior of skirt member 59 orthogonally with respect to trigger rod 62 and to repose slightly above the trigger rod 62, substantially as depicted in FIGS. 5-7. Somewhat generally at the intersection of locking bar 50 and trigger rod 60 within the interior of the skirt member 59, locking bar 50 fixedly carries a downward depending abutment or stop member 68 whereas trigger rod 60 includes an upstanding abutment or “dog” member 66 intended to be in abutting engagement therewith (FIG. 7) when the trap is in the “set” position.

A spiral spring assembly 70 suitably supported on the floor of annular bas member 14 is provided to bear against the underside of trigger rod 60 and normally to urge the trigger rod abutment or “dog” 66 into its intended engagement with trigger rod abutment 68 (FIGS. 5 and 7) when the trap is in its open or “set” position.

Substantially as schematically depicted by FIG. 6, when an animal's foot steps anywhere on the top surface of pan 30, the skirt member 59 is caused to travel sufficiently downward as indicated by arrow 70. This action causes the abutment 62 and its bearing surface 73 to depress the distal extremity 64 of trigger rod 60 against the bias of spring assembly 70 which, in turn, causes the “dog” 66 to disengage from its abutting (locking) relation with abutment 68 on locking bar 50. As indicated by arrow 72, the locking bar 50, which is now unrestrained, is free to rotate counterclockwise about its axis as viewed in FIG. 6, freeing the locking arms 52, 54 from their engagement with locking tabs 56, 58 and springing the trap, i.e. jaws 24, 26 close about the animal's foot under the influence of spring assemblies 44.

It will be appreciated that to set the trap, all that is necessary is to depress levers 32, 36, allowing the jaw members 24, 26 to fall to their open position (FIG. 2), then to rotate the locking bar 50 to its “locking” or “set' position until the locking arms engage the locking tabs 56, 58. This action automatically causes spring assembly 70 to urge the trigger rod 60 upwardly until “dog” 66 engages abutment 68 thereby establishing the relationship of parts substantially as depicted in FIGS. 5 and 7.

Turning now to FIGS. 8-15, a second alternatively preferred embodiment of my invention will now be described in considerable detail. In accordance with the invention, the second alternatively preferred embodiment of FIGS. 8-15 is a simplified iteration of the first embodiment of FIGS. 1-7 thereby making it less expensive and therefore more widely commercially available to the consuming public.

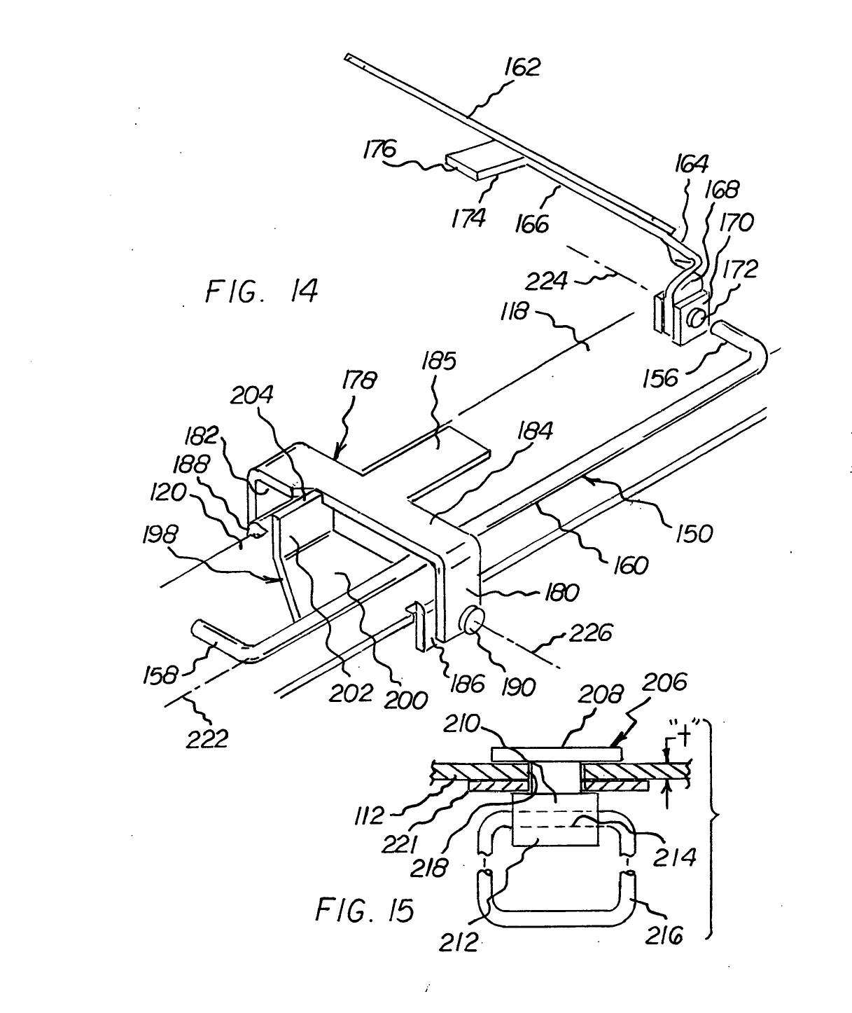

The second alternatively preferred embodiment of my foot-hold animal trapping apparatus generally is indicated by reference sign 110 and comprises a generally cruciform-shaped, substantially flat, base plate 112 having first and second opposed arm segments 114, 116 in nominal perpendicular relation to a pair of third and fourth opposed arm segments 118, 120, substantially as best seen in FIG. 11. Base plate 112 has a top surface 122, a bottom surface 124, and a thickness ‘t” (FIG. 15) and preferably is fabricated of machine steel stock or other known stiff, strong, durable material employed in the construction of animal traps.

As in the first preferred embodiment of FIGS. 1-7, the base plate 112 serves as a rigid platform or framework for supporting the primary components of the animal trap, namely the curved jaw members, the spring assemblies, the spring-driven jaw-lever members, the center or foot pan, and the trigger mechanism for setting the jaws in the “open” condition and for automatically activating the spring assemblies to drive the jaws to a “closed” condition when an animal steps anywhere on the top surface of the foot pan.

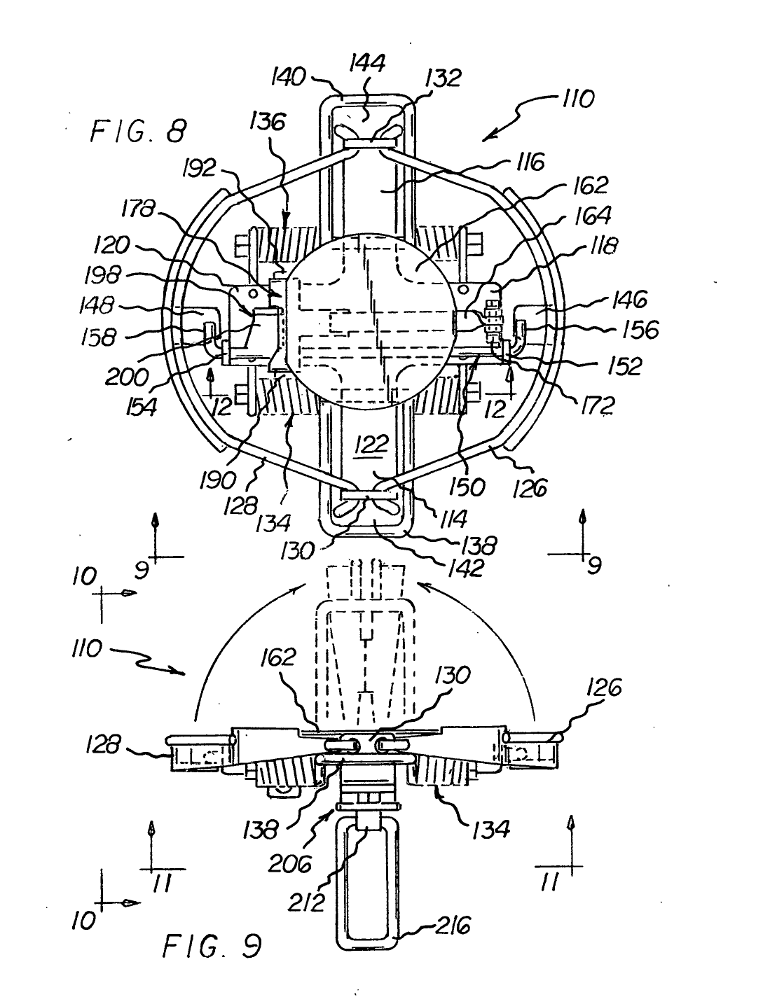

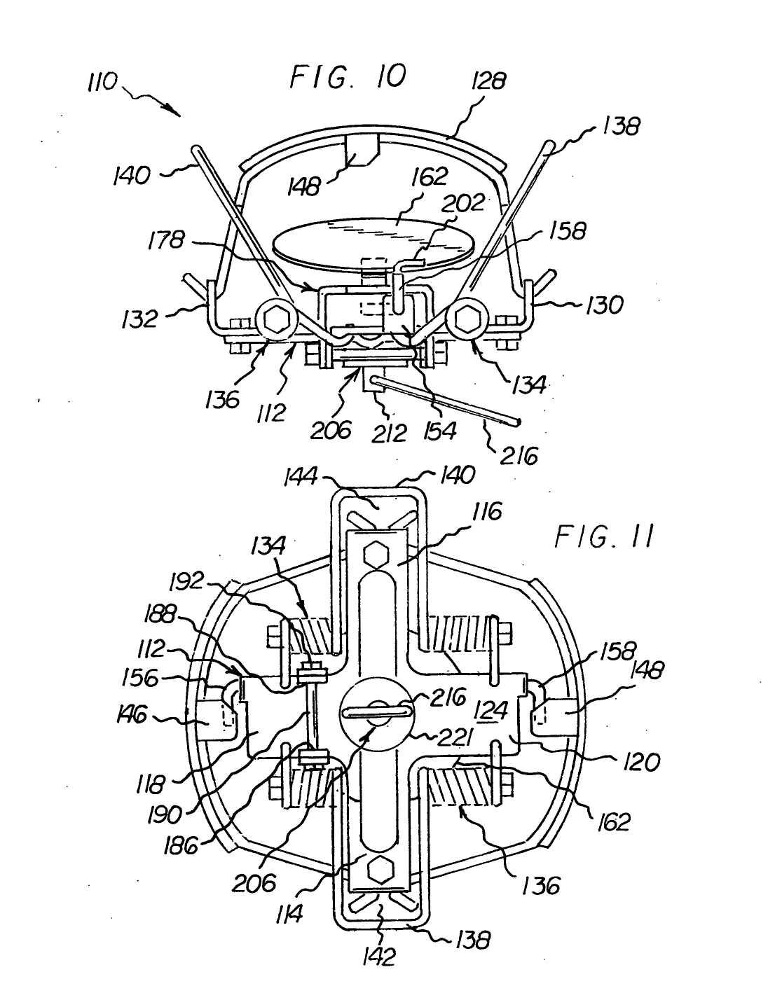

Thus, more specifically, first and second curved jaw members 126, 128 are suitably journaled in corresponding upright ears or lugs 130, 132 affixed to first and second opposed arm segments 114, 116, respectively. Conventional animal trap spiral spring assemblies 134, 136 suitably are fixedly mounted on first and second base arm segments 114, 116, respectively, generally parallel to each other and spaced from each other, and extend substantially perpendicular to the imaginary longitudinal axis (not shown) defined by third and fourth base arm segments 118, 120, substantially as depicted in FIGS. 8 and 11. As is well known in the art, each spring assembly 134, 136 includes a central, substantially rectangularly-shaped lever plate or jaw-pusher frame member 138, 140, respectively. Each lever plate 138, 140, in turn, has a central opening 142, 144 suitably dimensioned to defined transverse side portions on each lever plate sufficient for engaging first and second jaw members 126, 128 and urging them to move from the “open” position to the “closed” position, as is well known in the art. Thus, in FIGS. 8 and 9, the lever plates 138, 140 are shown in the down position corresponding to the “open” or “set” position of jaw members 126, 128 whereas in FIG. 10, the levers 138, 140 are shown in the fully “up” position (caused by the action of spring assemblies 134 and 136) corresponding to the “closed” or “trapping” position of the jaw members 126 and 128.

In order to “set” the trap and maintain the first and second jaw members 126, 128 in the open position, first and second jaw locking tabs or lugs 146, 148 are provided suitably rigidly affixed to each jaw member, respectively (FIGS. 8 and 11). A locking bar or member generally designated by reference sign 150, extends loosely through suitable openings in opposed, upright ears or lugs 152, 154 affixed to opposite ends of third and fourth base arm segments 118, 120, respectively, as best depicted in FIGS. 8, 10 and 11. By this arrangement, the locking bar 150 can rotate about an axis passing longitudinally through the bar, which axis as viewed in FIG. 8 extends generally parallel to base arm segments 118, 120 and generally perpendicular to base arm segments 114, 116. The longitudinal locking bar axis is designated by reference sign 222 in FIG. 14. The locking bar 150 terminates distally in first and second opposed end portions or arms 156, 158, respectively, bent or otherwise disposed substantially at right-angles to the straight or longitudinal portion 160 of the locking bar. The end portions 156, 158 and the straight portion 160 of locking bar 150 all are essentially co-planar in disposition.

Thus, it will be appreciated that when the locking bar straight portion 160 is rotated to the position shown in FIGS. 8 and 11, the locking bar end portions 156, 158 are capable of engaging first and second locking tabs 146, 148, respectively, to retain the first and second jaw members 126, 128 in a first “open” position provided the locking bar can be “locked” in this orientation, i.e. where the end portions 156, 158 extend horizontally so as to intercept an imaginary plane parallel to the base plate 112 (see FIGS. 8 and 11 where such imaginary plane is parallel to the plane of the paper).

In accordance with the invention, and as will be more fully described below, a unique trigger assembly or mechanism, sometimes referred to in the art as a “dog,” is provided for locking the locking bar 150 in the aforementioned first “set” or open position to maintain the first and second jaw members 126, 128 in the open position, and for being responsive to downward motion of the trap's foot pan to release the locking bar 150 causing it to rotate from a horizontal position to a vertical position with reference to its distal end portions 156, 158 thereby “springing” or activating the trap to a second “closed” animal restraining foot-holding position.

More specifically, a generally circular foot pan 162 nominally is centrally mounted above base plate 112 via hinged strut 164 which latter has a flat straight portion 166 suitably rigidly affixed to the underside of pan 162 and a downwardly bent, twisted, distal end section 168 which suitably is loosely fastened in bifurcated upright bushing 170, as best depicted in FIG. 14. The end section 168 of strut 164 has a through opening (not shown) registering with suitable openings in the bifurcated sections of bushing 170 (not shown) to receive a bolt and nut fastener 172, rivet, or the like. As a result of this construction, fastener 172 affixes the strut 164 to the hinge bushing 170 while the shank of fastener 172 serves as an axle permitting the strut end section 168, and consequently the pan 162, to move up and down, i.e. rotate freely about the axis defined by the fastener 172. The pan hinge axis is represented by reference sign 224 in FIG. 14.

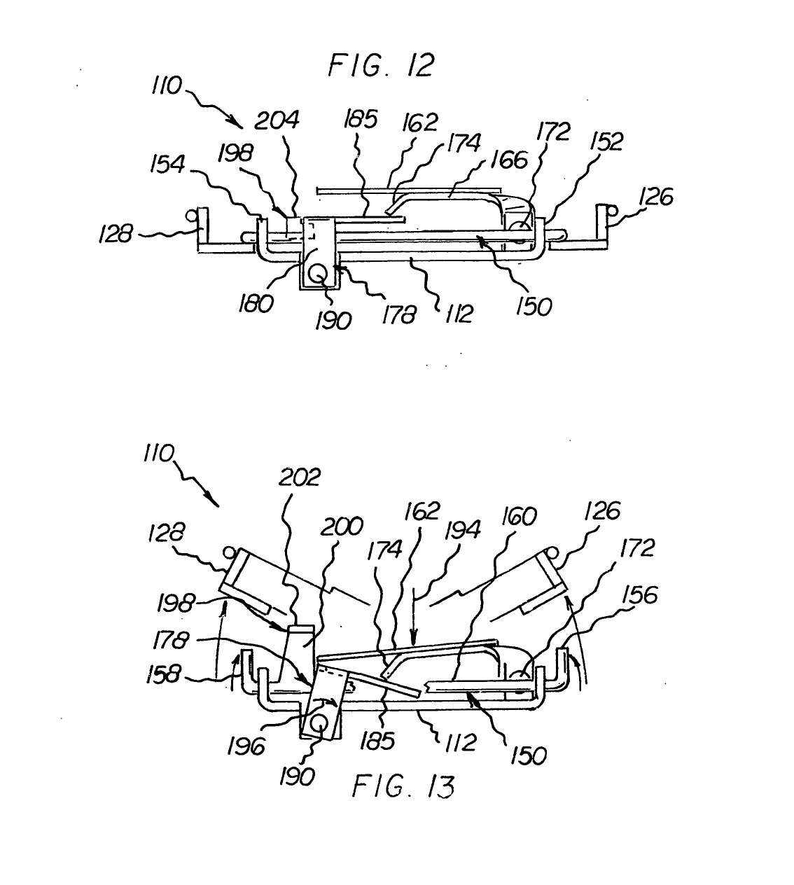

The opposite or proximal end portion of strut 164 defines a downwardly angled finger 174 having a free end edge 176 for engaging a movable locking plate 178 located on fourth base arm segment 120. The locking plate 178, sometimes referred to in the art as a “dog,” comprises a generally U-shaped yoke assembly characterized by a pair of downwardly extending opposed side portions or legs 180, 182, a transverse top portion 184 extending between legs 180, 182, and an axial extension 185 extending from the innermost edge of the transverse top portion 184 in an axial direction toward and facing bushing 170 in general axial alignment therewith (FIG. 14). As best depicted in FIG. 14, a pair of opposed, downwardly extending tabs or ears 186, 188 are provided on opposite edge portions of the fourth base arm segment 120 for supporting the locking plate assembly 178 at an axial location thereon generally underneath the peripheral edge portion of foot pan 162, which peripheral edge portion is distally remote from hinge bushing 170 and generally in axial alignment therewith (FIGS. 8 and 14). Extension 185 extends axially underneath pan 162 terminating substantially centrally thereof (FIGS. 12-13).

With reference to FIGS. 10-14, the locking plate assembly 178 (or “dog”) is affixed to the base fourth arm segment 120 (and opposed ears 186, 188) via a threaded bolt 190 passing through suitable registering openings (not shown) in the downwardly extending opposed side portions or legs 180, 182 of the locking plate 178 and through the like openings in the ears 186, 188 affixed to base arm segment 120. A locknut 192 preferably is employed for fastening the bolt in place. The locknut is tightened only sufficiently to permit the locking plate 178 to be rotated about an axis passing longitudinally through the center of bolt 190 in response to a downward force exerted when the foot pan 162 is lowered to a substantially horizontal position with its engagement finger free end edge 176 resting on and engaging axial extension 185 of locking plate 178 (FIG. 12). The locking plate rotation axis defined by fastening bolt 190 is represented by reference sign 226 in FIG. 14.

Subsequently, when an animal steps on the foot pan 162, the pan will be depressed downwardly, rotating the locking plate clockwise, substantially as depicted in FIG. 13 by arrows 194 and 196 (FIG. 13). In accordance with an important feature of the invention, it will be appreciated that by tightening or loosening locknut 192, the downward force required on pan 162 sufficient to rotate locking plate 178, via engagement of angled finger edge 176 against locking plate extension 186, can be varied over a suitable pre-determined range to permit selectable adjustment of the sensitivity of the foot pan to the force of an animal's foot stepping on the foot pan. Alternatively, a similar locknut can be provided on the pan hinge fastener 172 instead if it is desired to adjust the downward force on the pan required to activate the locking plate 178 to spring the trap in such alternative manner.

Attached to locking bar straight portion 160 is a trigger plate generally represented by reference sign 198. Trigger plate 198 has a base portion 200 extending generally parallel to and co-planar with locking bar first and second opposed end portions or arms 156, 158, which base portion 200 suitably is rigidly affixed to the locking bar straight portion 160 as by welding, for example. Trigger plate 198 further includes a distal trigger finger portion 202 having a top edge 204 which finger portion 202 extends upwardly from base portion 200 generally at a right angle thereto when the trap is “set” in an open or first condition, substantially as depicted in FIGS. 13 and 14. The base portion 200 of trigger plate 198 preferably is located axially along the longitudinal extent of locking bar straight portion 160 substantially as depicted in FIGS. 12 and 14, such that when the trap is “set,” the right-most portion of trigger finger portion 202 (top edge 204) engages the underside of transverse top portion 184 of locking plate 178. Preferably, the upper right-most corner of trigger finger portion 202 has a suitable right-angle notch cut into it to provide a shoulder for securely engaging with the edge of transverse top portion 184 of locking plate 178, substantially as depicted in FIG. 14.

In use, setting of the trapping apparatus of the second alternatively preferred embodiment of FIGS. 8-15 to its first or open position is extremely easy. All that is necessary is to: first open the jaws 126, 128 by pressing the corresponding lever plates down; then rotate the locking bar 150 to engage the jaw locking tabs 146, 148 on the open jaws with the locking bar ends 156, 158; next lock the locking bar in place by moving the locking plate 178 back to its original horizontal position where it engages the trigger finger 202; then finally, place the foot pan 162 on the locking plate so that the pan is substantially horizontal and the downwardly angled finger end edge 176 is in contact with the locking plate extension 185. This sequence of events will “set” the trap and yield the disposition of parts substantially as depicted in FIGS. 7, 8 and 12.

When an animal steps anywhere on foot pan 162, the pan will move down, finger 174 will depress the locking plate extension 185 and cause the locking plate 178 to rotate out of engagement with the trigger finger 202 on locking bar 150, enabling the spring assemblies to drive the lever plates upward and close the jaws. Following this sequence of events, the disposition of parts will appear substantially as depicted in FIG. 13.

To summarize, the alternatively preferred embodiment of FIGS. 8-14 employs a nominally central foot pan 162 pivotally mounted on the frame 112 to release the locking plate or “dog” 178. In this regard, the pan pivot or hinge is mounted on one side of the pan and the locking plate is mounted on the opposite or other side of the pan. This allows the pan to tip down on the locking plate extension (or “tail”) 185 when an animal steps on the pan “pushing down” on the “dog” to release its locking engagement with the locking bar (jaw holddown rod 150). By having the pan sit on top of the locking plate and pushing down on the locking plate in accordance with the present invention, “dead spots” or “dead zones” virtually are eliminated. Finally, it will be observed with particular reference to FIG. 14 that in the alternatively preferred embodiment of FIGS. 8-14, the pan pivot axis 224 generally is parallel to the locking plate movement axis 226, and the locking bar longitudinal axis 222 generally is perpendicular to both the pan pivot axis and locking plate movement axis, substantially as depicted.

Preferably a “swivel” connection mounted in base plate 112 is provided for connecting the trapping apparatus embodiment of FIGS. 8-14 to a buried ground spike or like anchoring device via a chain (not shown). Such a “swivel” connection is schematically depicted in more detail in FIG. 15. Substantially as schematically depicted, the “swivel” connection comprises a rivet assembly generally represented by reference sign 206 having an enlarged top head 208, a shaft 210, and a bottom bushing 212 with a through opening 214. A link 216 for a connecting chain (not shown) passes through opening 214. The shaft 210 of the swivel rivet assembly is disposed in an enlarged through opening 218 in base plate 112 more or less centered on the central vertical axis (not shown) of the base plate 112. By this construction, the rivet assembly 206 is free to rotate 360 degrees relative to the trap's central axis as indicated by arrow 220. A washer 221 preferably is provided between bottom bushing 212 and the bottom surface 124 of base plate 112 (see also FIG. 11). The same or similar “swivel” connector assembly may be employed in the embodiment of the invention illustrated in FIGS. 1-7.

From, the foregoing, it further will be appreciated that the novel “center-driven” pan and trigger assembly employed in both embodiments of the present invention as disclosed herein overcomes a vexing problem affecting prior art “foot-hold” traps of the type herein concerned, by providing an animal trap where the trigger assembly is responsive to the pan moving axially downwardly toward the base plate when stepped on by an animal's foot, all but eliminating the “dead spot” or “dead zone” problem affecting the prior art traps where pivotally mounted pans and jaw-edge trigger mechanisms are employed.

As to the manner of usage and operation of the instant invention, the same is apparent from the above disclosure, and accordingly, no further discussion relative to the manner of usage and operation need be provided.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. Accordingly, it is desired that the present invention be limited only by the true spirit and scope of the appended claims.

What is claimed as being new and desired to be protected by Letters Patent of the United States is as follows:

1. Animal trapping apparatus comprising;
a frame,
a pair of complementary jaws rotatably mounted on said frame,
at least one spring assembly on said frame for cooperating with said pair of opposed levers for urging said complementary jaws toward each other from a first open position to a second closed or animal foot-holding restraining position,
a foot pan movably mounted on said frame, and
a trigger assembly located on said frame axially below said movably mounted foot pan, said foot pan having a top surface and a bottom surface, said trigger assembly including a first portion engageable with said bottom surface of said pan and a second portion releasably engageable with said first portion and being effective to restrain said complimentary jaws in said first open position when in engagement with said first portion,
wherein said first portion of said trigger assembly is responsive to downward movement of said pan on said frame when an animal steps on said foot pan to cause said first portion to release engagement with said second portion whereby said at least one spring assembly causes said pair of opposed levers to urge said complementary jaws toward each other from said first open position to said second closed or animal foot-holding restraining position,

2. The apparatus of claim 1 wherein said trigger assembly first portion comprises a first locking member adapted to be engaged by said bottom of said foot pan, and wherein said trigger assembly second portion comprises a second locking member adapted to be in engagement with said pair of complimentary jaws.

3. The apparatus of claim 2 wherein said first locking member comprises a locking plate movably mounted on said frame between said frame and said movable foot pan.

4. The apparatus of claim 3 wherein said locking plate is pivotally supported on said frame and is spaced axially between said frame and said bottom surface of said foot pan, and wherein said foot pan is pivotally supported on said frame, and wherein the pivot axis of said locking plate extends substantially parallel to the pivot axis of said foot pan.

5. The apparatus of claim 3 wherein said foot pan is located between the pivot axis of said foot pan and the pivot axis of said locking plate with respect to said frame.

6. The apparatus of claim 3 wherein said pair of complimentary jaws each has a locking tab, and wherein said second locking member comprises a locking bar having opposed ends, and wherein said opposed ends of said locking bar are adapted to engage said complimentary jaw locking tabs, respectively, when said complimentary jaws are in said first open position.

7. The apparatus of claim 6 wherein said locking bar is pivotally supported on said frame, and said locking bar has a pivot axis perpendicular to the pivot axis of said locking plate.

8. The apparatus of claim 7 wherein said locking bar has a trigger finger, said trigger finger being adapted to engage said locking plate when said complimentary jaws are in said first open position, and wherein said trigger finger is adapted to be disengaged from said locking plate when said foot pan moves downwardly against said locking plate to cause said locking plate to pivot about said locking plate pivot axis whereby said at least one spring assembly causes said pair of opposed levers to urge said complementary jaws toward each other from said first open position to said second closed or animal foot-holding restraining position as aforesaid.

9. The apparatus of claim 8 wherein said foot pan includes a downwardly depending finger disposed on its said bottom surface, said downwardly depending finger being adapted to pivot said locking plate about said locking plate pivot axis to cause said trigger finger on said locking bar to pivot on its said pivot axis and thereby become disengaged from said locking plate when said foot pan moves downwardly against said locking plate.

10. The apparatus of claim 2 wherein said first locking member comprises a locking bar movably mounted on said frame between said frame and said movable foot pan,
and wherein said locking bar is pivotally supported on said frame and is spaced axially between said frame and said bottom surface of said foot pan, and wherein said foot pan is supported for axial movement on said frame, and wherein the pivot axis of said locking bar extends substantially perpendicular to axis of movement of said foot pan.

11. The apparatus of claim 1 wherein said trigger assembly first portion comprises a first locking member connected to said bottom of said foot pan, and wherein said trigger assembly second portion comprises a second locking member adapted to be in engagement with said pair of complimentary jaws, and wherein said foot pan is mounted on a cylindrical skirt, said cylindrical skirt being received within a cylindrical housing, said cylindrical housing being mounted on said frame, and wherein said cylindrical skirt is supported for telescopic axial movement within said cylindrical housing.

12. The apparatus of claim 11 wherein said first locking member comprises a first abutment, said first abutment being located on the inside wall surface of said cylindrical skirt, said first locking member further including a locking bar, said locking bar being pivotally mounted on said frame, a resilient biasing member mounted on said frame for engaging said locking bar and urging said locking bar into engagement with said first abutment, and a second abutment on said locking bar, said second abutment engaging said second locking member when said pair of complimentary jaws are in said first open position.

13. The apparatus of claim 12 further including first and second pairs of opposed registering openings commonly extending through said cylindrical skirt and said cylindrical housing, and a third pair of opposed registering openings extending through the telescoping sidewalls of said cylindrical skirt and said cylindrical housing to terminate interiorly of said skirt member, wherein said second locking member adapted to be in engagement with said pair of complimentary jaws extends through said first and second pairs of opposed registering openings commonly extending through said cylindrical skirt and said cylindrical housing, and wherein said locking bar extends through said third pair of opposed registering openings extending through the telescoping sidewalls of said cylindrical skirt and said cylindrical housing to terminate interiorly of said skirt member, said locking bar being urged into engagement with said second locking member by said resilient biasing member mounted on said frame whereby telescopic movement of said cylindrical skirt downward within said cylindrical housing is effective to cause said first abutment to release said locking bar from its engagement with said second locking member.
